(19) United States
(12) Patent Application Publication
(10) Pub. No.: US 2026/0080614 A1
(43) Pub. Date: Mar. 19, 2026

(54) EFFICIENT 3D OBJECT CREATION BY GROUPING POINT CLOUD DATA

(71) Applicant: SAP SE, Walldorf (DE)

(72) Inventors: Igor AFANASYEV, Rolleston (NZ); Dmitriy KIVILEV, Dunedin (NZ); Slavko SNJEGOTA, Auckland (NZ)

(21) Appl. No.: 18/929,907

(22) Filed: Oct. 29, 2024

Related U.S. Application Data
(60) Provisional application No. 63/695,912, filed on Sep. 18, 2024.

(51) Int. Cl. G06T 17/00

(52) U.S. Cl. CPC G06T 17/00

(57) ABSTRACT

Embodiments are described for a graphic segmentation device comprising a memory and at least one processor coupled to the memory. The at least one processor is configured to receive point cloud data that represents a plurality of 3D objects and select one or more 3D volumes that segment a 3D object out of the plurality of 3D objects. Each of the one or more 3D volumes includes coordinates forming a 3D shape. The at least one processor is further configured to transmit a volume report to a graphic segmentation server, wherein the volume report includes the one or more 3D volume.

### CROSS REFERENCES

This application claims the benefit of U.S. Provisional Application No. 63/695,912 filed Sep. 18, 2024, titled “EFFICIENT 3D OBJECT CREATION BY GROUPING POINT CLOUD DATA,” the content of which is herein incorporated by reference in its entirety.

### BACKGROUND

Three-dimensional (3D) objects can be represented using a plurality of points in a 3D space. In some cases, multiple 3D objects can be adjacent to or even connected with each other. Thus, it may be beneficial to perform segmentation that separates the multiple 3D objects. However, each of the multiple 3D objects may be represented by a large number of points. Thus, performing segmentation can be technically challenging.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example 3D objections segmentation system, according to some embodiments of the disclosure.

FIG. 2 illustrates a block diagram of an example 3D objections segmentation system, according to some embodiments of the disclosure.

FIG. 3 illustrates an example method of segmenting 3D objects, according to some embodiments of the disclosure.

FIG. 4 illustrates an example method of segmenting 3D objects at a client device, according to some embodiments of the disclosure.

FIG. 5 illustrates an example method of segmenting 3D objects at a server, according to embodiments of the disclosure.

FIG. 6 illustrates an example computer system for implementing some embodiments of the disclosure or portion(s) thereof.

FIG. 7 illustrates an example method of a server segmenting 3D objects, according to some embodiments of the disclosure.

FIG. 8 illustrates an example method of a client device segmenting 3D objects, according to some embodiments of the disclosure.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments of this disclosure include apparatus, system, computer program product, and method embodiments for implementing 3D objects segmentation.

In some embodiments, 3D objects can be represented by 3D points in a 3D space. For example, the 3D points can form a shape and/or a geometry of 3D objects. Each of the 3D points may include 3D coordinates such as (X, Y, Z). In some embodiments, the 3D points may be generated by scanning the 3D objects. For example, the 3D points can be generated using a light detection and ranging (LIDAR) system. The LIDAR system can emit laser pulses and measure the time it takes for them to bounce back from the 3D objects. The LIDAR system can then calculate the 3D coordinates of the 3D points based on the time it takes for bouncing. Other scanning tools and methods, such as photogrammetry, structured light scanning, and time-of-flight cameras, can also be used to generate the 3D points based on the 3D objects. In some embodiments, a plurality of 3D objections may be adjacent to or connected with each other. For example, an automobile may include different 3D objects, such as tires, lights, windows, front hood, back hood, bumpers, and so on. Because all these 3D objects are connected with each other, the LIDAR system or other scanning tools may generate 3D points representing the automobile as a whole without identifying which 3D points correspond to which part of the automobile. In such a case, it may be difficult to use 3D points of individual 3D objects. For example, reconstructing the tires, either digitally or physically, may require extracting 3D points corresponding to the tires, not 3D points of the automobile as a whole. Thus, it is beneficial to segment different parts of the automobile as individual 3D objects. In some embodiments, a 3D segmentation system can group together 3D points corresponding to a 3D object out of a plurality 3D objects. For example, the 3D segmentation system can group 3D points corresponding to a front driver-side tire together to generate a set. The 3D segmentation system can also label the set as the front driver-side tire. The 3D segmentation system may also give the set properties such as color, shape, material, and so on. Finally, the 3D segmentation system may transmit the 3D points of the set to another device for further analysis or use.

In some embodiments, the 3D segmentation system may include a server, such as a graphic segmentation server. The server can store 3D points generated via scanning. For example, the server can receive the 3D points, e.g., 3D coordinates of the 3D points, from a scanning tool, such as a LIDAR system or others. For another example, the server may be capable of scanning 3D objects and thus may generate the 3D points by itself. In either case, the server may store the 3D points and thus can perform segmentation of the 3D objects. In some embodiments, the server can receive instructions from a user who operates the server in order to perform the segmentation. For example, the server can illustrate a 3D representation of the automobile using the 3D points. Thus, the user can select 3D points corresponding to a tire, such as the front driver-side tire, in the 3D representation. Specifically, the user can create or select a 3D volume. The user can adjust a size and a position of the 3D volume so that the 3D points of the tire are located within the 3D volume. For example, the 3D volume can be a cuboid. The user can adjust a height, a width, and/or a length of the cuboid and can move the cuboid to different positions. After the user creates the 3D volume, the server can extract 3D points located within the 3D volume and group them together as a set.

In some embodiments, the user may not have access to the server. For example, the server may be located in a remote data center. For another example, the server may be behind a firewall or in a secured facility. Thus, it may be difficult or even impossible for the user to create a 3D volume using the server as discussed above. In such a case, the server can transmit 3D points to a client device, such as a graphic segmentation device, which can be accessed by the user. In some embodiments, the client device can perform the segmentation using the 3D points received and transmit 3D points corresponding to the tire back to the server. For example, the user can create the 3D volume using the client device. The client device may then select a set of 3D points out of all the 3D points received from the server based on the 3D volume. Each 3D point in the set of 3D points is located within the 3D volume. Finally, the client device may transmit the set of 3D points back to the server.

In some embodiments, the above approach requires transmitting a large amount of data between the server and the client device. For example, the 3D point representing the 3D object, such as the automobile, may be stored in point cloud data of a size of hundreds of gigabytes (GB) or more. Thus, it may take a long time for the client device to receive the point cloud data from the server. Similarly, the set of 3D points selected by the client device may also be large data. Thus, it may also take a long time for the client device to transmit the set of 3D points to the server. In addition, the client device may not even have enough space to store the point cloud data, let alone perform the segmentation based on the point cloud data. Thus, reducing data transmission between the server and the client device may be necessary to enable the client device to perform the segmentation.

In some embodiments, the server can reduce an amount of data transmitted from the server to the client device. For example, the server can set an upper bound on a number of 3D points to be included in the point cloud data transmitted to the client device. In some embodiments, the upper bound can be a predefined number. For example, the client device can report the predefined number to the server. The server may then generate point cloud data by limiting the number of 3D points included to be less than or equal to the predefined number when the server needs to send 3D points to the client. For another example, the upper bound can be dynamically configured. In some embodiments, the client device can report the upper bound periodically or whenever there is a need to transmit the point cloud data. The client device can also report a capability of the client device to the server. In such a case, the server can determine the upper bound based on the capability. For example, the capability can be storage capacity, processing power, communication bandwidth, or other properties of the client device. In some embodiments, when the LIDAR system or other scanning tools generates a number of 3D points that is larger than the upper bound, the server may retrieve a reduced number of 3D points from the number of 3D points, wherein the reduced number is smaller than or equal to the upper bound. The server may then generate the point cloud data using the reduced number of 3D points. Thus, the data transmission from the server to the client device can be reduced to the upper bound. In some embodiments, the client device may also set a lower bound on the number of 3D points to be included in the point cloud data. For example, the lower bound may be a number of 3D points required to generate a representation of 3D objects so that the user can observe and distinguish different 3D objects in the representation. The lower bound can be a predefined number determined by the server. The lower bound can also be a dynamic number corresponding to a size of the 3D objects. In either case, when the LIDAR system or other scanning tools generates a number of 3D points that is smaller than the lower bound, the server may configure the LIDAR system or other scanning tools to perform additional scanning until it generates more 3D points than the lower bound.

In some embodiments, the client device can reduce an amount of data transmitted from the client device to the server. For example, instead of transmitting the set of 3D points selected by the client device from the client device to the server, the client device may transmit the 3D volume back to the server. As discussed above, the 3D volume may be a cuboid. Thus, the client device may report coordinates of each corner of the cuboid. In such a case, the server can reconstruct the 3D volume and select the set of 3D points from 3D points stored in the server. Because the cuboid has only 8 corner points, the client device may only need to transmit 8 coordinates to the server. In some embodiments, the cuboid can be represented by a position, a rotation, a size, and a type.

For example, the position can include three coordinates in the 3D space, such as values (X, Y, Z). The position can be a center of the cuboid or other positions of in the cuboid.

The rotation can be represented by quaternion, which includes four values (RX, RY, RZ, W). The size can include three values (SX, SY, SZ). Finally, the type can be either “add” or “subtract,” as discussed in more detail below. In such a case, even less data is required to represent the cuboid. In either way of representing the cuboid, the amount of data transmitted from the client device to the server is reduced.

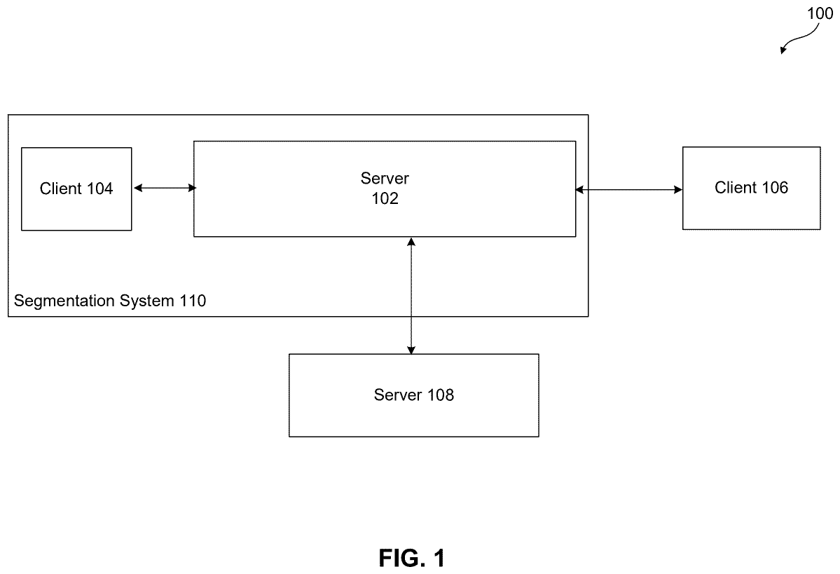

FIG. 1 illustrates an example 3D objections segmentation system, according to some embodiments of the disclosure. The example system 100 is provided for the purpose of illustration only and does not limit the disclosed embodiments. The example system 100 may include, but is not limited to, a segmentation system 110 including a server 102 and a client device 104, a client device 106, and a server 108. In some embodiments, the server 102, the client device 104, the client device 106, and the server 108 may include, but is not limited to, computer systems, servers, cloud systems, cloud servers, laptops, desktops, personal computers, databases, user equipment, and the like. The server 102 can also be referred to as a graphic segmentation server. The client device 104 can also be referred to as a graphic segmentation device.

In some embodiments, the server 102 may receive 3D point data from a scanning tool. For example, a LIDAR system or other scanning tools may scan one or more objects to generate a plurality of 3D points. Each of the plurality of 3D points includes a 3D coordinates, such as (X, Y, Z) and the 3D point data may include coordinates of each of the plurality of 3D points. After receiving the 3D point data, the server 102 may store the 3D point data in a memory of the server 102. In some embodiments, the scanning tool may be integrated with the server 102 or included in the server 102. In such a case, the scanning tool may transmit the 3D point data via an internal communication channel to the memory of the server 102.

In some embodiments, the server 102 may transmit the 3D point data to the client device 104. For example, the server 102 may generate cloud point data using the 3D point data. The cloud point data may include coordinates of the 3D points. In other words, the server 102 may transmit the 3D point data received from the scanning tool to the client device 104. As discussed above, the 3D point data may be as large as hundreds of GBs.

Thus, the server 102 may retrieve a part of the 3D point data and generate the point cloud data using the part of the 3D point data. For example, the server 102 may determine that the point cloud data include at most a first number of 3D points. However, the 3D point data received from the scanning tool may include a second number of 3D points. The second number may be larger than the first number. In such a case, the server 102 may select the first number of 3D points from the second number of 3D points. For example, the server 102 may randomly select the first number of 3D points. After retrieving the first number 3D points and generating the point cloud data, the server 102 may transmit the point cloud data to the client device 104.

In some embodiments, the client device 104 may receive the point cloud data via a wireless connection, a wired connection, or a combination of both, from the server 102.

The client device 104 may then generate a 3D representation of the one or more 3D objects using the point cloud data. Depending on a number of 3D points included in the point cloud data and sizes of the one or more 3D objects, the representation may illustrate different levels of details of the one or more 3D objects. A user of the client device 104 may observe the representation using the client device 104. In some embodiments, the client device 104 may segment the one or more 3D objects using 3D volumes. For example, the client device 104 may create one or more 3D volumes based on instructions from the user. The one or more 3D volumes may be cuboids or other shapes. The client device 104 may adjust sizes, positions, and orientations of the one or more 3D volumes so that a combination of the one or more 3D volumes encompasses a 3D object out of the one or more 3D objects. For example, the one or more 3D volumes may encompass a tire of the automobile. In some embodiment, the client device 104 may transmit coordinates of the one or more 3D volumes to the server 102. For example, the coordinates may be coordinates of corner points of the one or more 3D volumes. Thus, the server 102 can reconstruct the one or more 3D volumes using these coordinates.

In some embodiments, the server 102 may reconstruct the combination of the one or more 3D volumes. Furthermore, the server 102 may determine that a set of 3D points in the 3D point data are located within the combination of the one or more 3D volumes.

The server 102 may group the set of 3D points together and label it as the 3D object encompassed by the combination of the one or more 3D volumes. For example, the server 102 may label the set of 3D points to be the tire of the automobile.

In some embodiment, the client device 104 may be designated as a segmentation device. The user of the client device 104 may have the expertise and authorization to perform segmentation using the client device 104. In addition, the client device 104 may have the hardware capability to perform segmentation based on instruction received from the user. Furthermore, the client device 104 and the server 102 may be placed in a secured facility or behind a firewall so that segmentation is allowed. In some embodiments, the client device 104 and the server 102 may form the segmentation system 110 so that one or more 3D objects can be segmented using both the client device 104 and the server 102. In summary, the client device 104 and the server 102 may be designated to perform the segmentation, but not other devices, such as the client device 106 and the server 108.

In some embodiments, the server 102 may transmit the set of 3D points to the client device 106 for further analysis or use. As discussed above, the client device 106 may not be capable or allowed to perform segmentation of the one or more 3D objects. However, the client device 106 may be capable and allowed to process segmented 3D objects. For example, the set of 3D points may represent a tire of an automobile. The client device 106 may configure the tire by changing its color, shape, size, or other properties using the set of 3D points. The client device 106 may generate an updated set after the changes and may transmit the updated set back to the server 102. The server 102 may integrate the updated set into the 3D point data so that the changes to the tire can be realized.

In some embodiments, the server 102 may transmit the 3D point data to the server 108. Similarly to the set of 3D points that represents a tire of an automobiles, the server 102 may group 3D points into other sets that represent other 3D objects. The server 102 may transmit such grouping information to the server 108 so that the one or more 3D objects are segmented. For example, each of the 3D points in the 3D point data may be labeled to its group. Thus, the 3D points in the set corresponding to the tire may be labeled as the tire. In some embodiments, each 3D points may include one or more digits that represent the grouping. For example, a 3D point may include (X, Y, Z, G) where “X” “Y” and “Z” are 3D coordinates and “G” represents grouping. A front driver-side tire may be labeled as “1.” In such a case, a point in the set of 3D point representing the front driver-side tire may include (X, Y, Z, 1). 3D points of other 3D objects can be similarly labeled. Accordingly, the server 108 can process the 3D point data without needing to perform segmentation. For example, the server 108 may transmit 3D points of different 3D objects to different client devices.

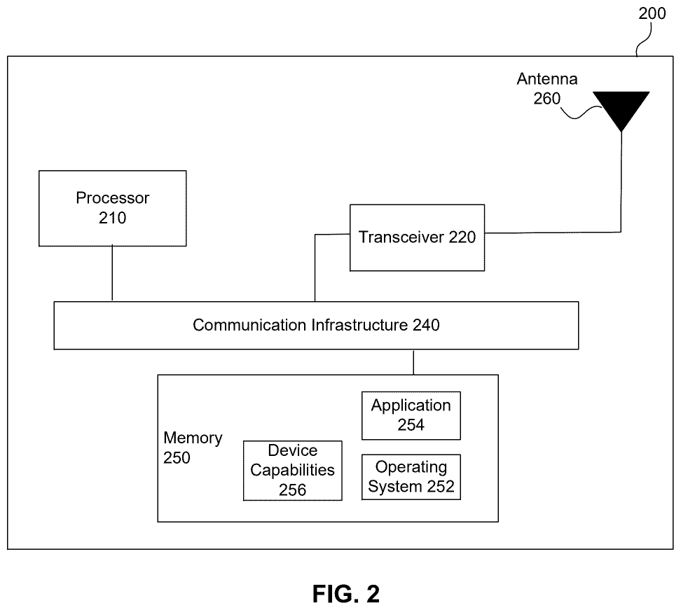

FIG. 2 illustrates a block diagram of an example 3D objections segmentation system, according to some embodiments of the disclosure. The electronic device 200 may be any of the electronic devices (e.g., the server 102, the client device 104, the client device 106, the server 108, or a combination thereof of FIG. 1) of the system 100. The electronic device 200 includes a processor 210, one or more transceivers 220, a communication infrastructure 240, a memory 250, an operating system 252, an application 254, device capabilities 256, and antenna 260. Illustrated systems are provided as exemplary parts of electronic device 200, and electronic device 200 may include other circuit(s) and subsystem(s). Also, although the systems of electronic device 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. In some embodiments, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for 3D segmentation, as described herein. Alternatively, or additionally, the processor 210 can be “hard coded” to implement mechanisms for the 3D segmentation, as described herein.

The one or more transceivers 220 transmit and receive communications signals support mechanisms for the orientation assist in a 3D objections segmentation system.

Additionally, the one or more transceivers 220 transmit and receive communications signals that support mechanisms for measuring communication link(s), generating and transmitting system information and data, and receiving the system information and data. According to some embodiments, the one or more transceivers 220 may be coupled to the antenna 260 to wirelessly transmit and receive the communication signals. The antenna 260 may include one or more antennas that may be the same or different types and can form one or more antenna ports. In some embodiments, the antenna 260 can be replaced or used in combination with wired communication interferences, such as Ethernet, Universal Serial Bus (USB), serial port, serial advanced technology attachment (SATA), and fiber optic interferences. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some embodiments of this disclosure, the one or more transceivers 220 may include a cellular subsystem, a WLAN subsystem, and/or a Bluetooth^{TM} subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver. Additionally, the one or more the transceivers 220 may include one or more circuits (including a cellular transceiver) for connecting to and communicating on cellular networks.

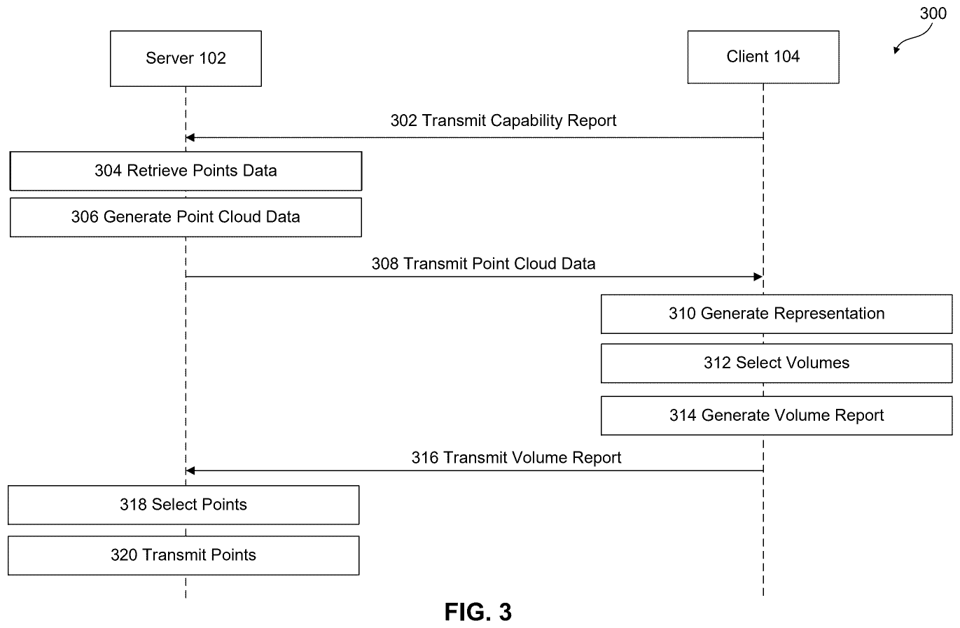

As discussed in more detail below with respect to FIGS. 3-6, processor 210 may implement different mechanisms for the orientation assist in a 3D objections segmentation system as discussed with respect to the system 100 of FIG. 1.

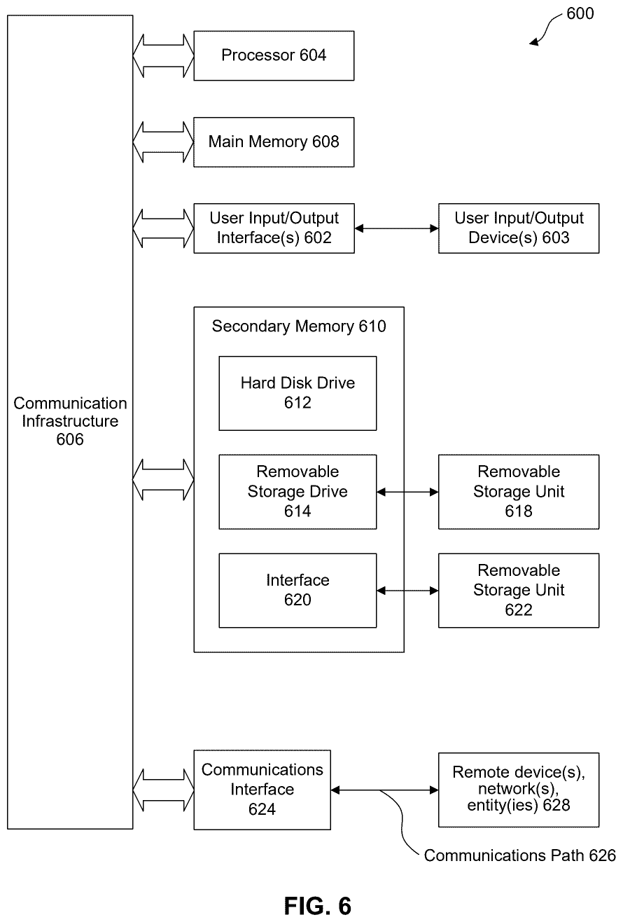

FIG. 3 illustrates an example method 300 of segmenting 3D objects, according to some embodiments of the disclosure. As a convenience and not a limitation, FIG. 3 may be described with regard to elements of FIGS. 1, 2, and 6. The example of a programming layout 300 may represent the operation of devices (e.g., the server 102, the client device 104, the client device 106, the server 108, or a combination thereof of FIG. 1) implementing the 3D segmentation in a 3D objections segmentation system. The example of a programming layout 300 may also be performed by computer system 600 of FIG. 6. But the example of a programming layout 300 is not limited to the specific embodiments depicted in those figures and other systems may be used to perform the method, as will be understood by those skilled in the art. It is to be appreciated that not all operations may be needed, and the operations may not be performed in the same order as shown in FIG. 3.

At 302, a client device, such as the client device 104, may transmit a capability report to a server, such as the server 102. The capability report may indicate hardware capabilities of the client device 104. In some embodiments, the hardware capabilities may include a storage capability, a processing capability, a communication capabilities, or others.

At 304, the server 102 may retrieve 3D point data from a memory of the server 102. In some embodiments, the server 102 may have previously received the 3D point data from a 3D scanning tool. As discussed above, the 3D scanning tool may be remotely located from the server 102 or integrated into the server 102. In either case, the 3D scanning tool may generate the 3D point data by scanning one or more 3D objects that are connected together. For example, the 3D scanning tool may scan an automobile that includes different 3D objects such as tires, lights, windows, front hood, back hood, bumpers, and so on. Because these 3D objects are connected to each other, the 3D scanning tool scans the 3D objects as a whole to generate the 3D point data. In other words, the 3D point data may include 3D points that are associate with different 3D objects. However, when the server 102 retrieves the 3D point data, the server 102 does not distinguish 3D points based on the associated 3D objects.

At 306, the server 102 may generate point cloud data based on the 3D point data. In some embodiments, the point cloud data may include the 3D points of the 3D point data. In other embodiments, the point cloud data may include a part of the 3D point data. For example, the server 102 may limit a number of 3D points to be included in the point cloud data. When the 3D point data include more 3D points than the limit, the server 102 may select a part of the 3D point data to be included in the point cloud data. For example, if the 3D point data may include 100,000 3D points, but the server 102 may limit the point cloud data to have 1,000 3D points, the server 102 may randomly select 1,000 3D points from the 100,000 3D points of the 3D point data. The server 102 may then generate the point cloud data using the 1,000 3D points selected. In some embodiments, the server 102 may select the 3D points (e.g., 1,000 3D points) by skipping other 3D points. For example, the 3D scanning tool may generate the 3D points (e.g., 100,000 3D points) in order by scanning the one or more 3D objects densely from top to bottom. Points that are generated close to each other represent a same area of the one or more 3D objects. Thus, to generate the point cloud data that represent the one or more 3D objects sparsely, the server 102 may skip a certain number of 3D points. For example, the server 102 may skip 99 3D points in every 100 3D points. In other words, the server 102 may use one 3D point to represent every 100 3D points. In this way, the server 102 selects 1,000 3D points out of 100,000 3D points to generate the point cloud data.

In some embodiments, the server 102 may determine the limit based the hardware capacities of the client device 104. For example, the client device 104 may indicate in the capability report that the client device 104 is capable of storing and processing X GB of data. In such a case, the server 102 may determine that 1,000 3D points require X GB storage space and thus limit the point cloud data to include no more than 1,000 3D points. In other embodiments, the client device 104 may indicate the limit directly. For example, the capability report may indicate that the point cloud data should include no more than 1,000 3D points.

At 308, the client device may receive the point cloud data from the server 102.

The client device may receive the point cloud data via a wireless connection, a wired connection, or a hybrid connection to the server 102.

At 310, the client device 104 may generate a 3D representation using the point cloud data. The level of details in the 3D representation may depend on the number 3D points in the point cloud data. In some embodiments, the client device 104 may down-sample the point cloud data by further reducing the number of 3D points in the point cloud data. Furthermore, the client device 104 may convert the point cloud data to a 3D mesh. For example, the client device 104 may connect neighboring 3D points to form triangular surfaces. In some embodiments, the client device 104 may display the 3D representation on a screen of the client device 104 so that a user of the client device 104 can observe the 3D representation. In some embodiments, the client device 104 may down-sample the point cloud data based on a resolution of the screen of the client device 104.

At 312, the client device 104 may select one or more volumes for each of the 3D objects according to instructions from the user. For example, for a tire of an automobile, the client device 104 may select the one or more volumes so that a combination of the one or more volumes encompasses the tire. In some embodiments, the one or more volumes may have a predetermined shape, such as a cuboid. The client device 104 may determine a size, a position, and an orientation of the one or more volumes. For example, the client device 104 may select a cuboid that encompasses the tire. In such a case, only a first 3D volume is needed. The client device 104 may adjust a size and an orientation of the first 3D volume to fit the tire and move the first 3D volume to a position of the tire. In some embodiments, the tire may be dual tires. In such a case, the client device 104 may select the first 3D volume and a second 3D volume, each encompasses one of the dual tires. For example, after adjusting the size and the orientation of the first and the second 3D volumes, the client device 104 may move the first and the second 3D volumes to the position of the tire. The client device 104 may also combine the first and the second 3D volumes by labeling both as associated with the tire. In some embodiments, the client device 104 also labels the first and the second 3D volumes as “add” or “adding” to indicate that the first and the second 3D volumes are to be added when combining each out. In some embodiments, the client device 104 may want to exclude spaces from existing selected 3D volumes. For example, the dual tire may include two tires connected by a connecting part. The first and the second 3D volumes may include the connecting part as well as the two tires. However, the client device 104 may want to exclude the connecting part leaving the two tires in the combination of 3D volumes. In such a case, the client device 104 may select a third 3D volume that encompasses just the connecting part. The client device 104 can then combine the first and the second 3D volumes with the third 3D volume by labeling the third 3D volumes as “subtracting. ” Thus, when combining the 3D volumes, the client device 104 or other devices may add the first and the second 3D volumes and then subtract the third 3D volume.

In some embodiments, the client device 104 may group 3D volumes for each 3D object by labeling them for each 3D object. For example, the client device 104 may select three 3D volumes for the tire as discussed above. The client device 104 may label the three 3D volumes as a front driver-side tire or a value corresponding to the front driver-side tire. The client device 104 may also select and group 3D volumes for other 3D objects similarly.

At 314, the client device 104 may generate a volume report. In some embodiments, the volume report may include 3D volumes selected in the step 312. For the front driver-side tire, the volume report may include coordinates of the three 3D volumes as well as the label of the front driver-side tire. For example, the volume report may include an entry for the first 3D volume of the front driver-side tire as (C1, C2, C3, . . . , Cn, G, P). C1, C2, C3, . . . ., Cn may be coordinates of corner points of the first volume, assuming that the first volume has n corner points. G may be the label of the front driver-side tire. G could be a number or a letter as long as it represents the front driver-side tire. P may be a combination property of the 3D volume, which can be either “adding” or “subtracting,” as discussed above. P can be a binary digit where “1” means “adding” and “0” means “subtracting.” The volume report may also include the second and third 3D volume of the front driver-side tire in a similar fashion. In this way, the volume report includes three 3D volumes needed for the tire. In addition, the volume report may include 3D volumes for other 3D objects similarly.

In some embodiments, the volume report may also include metadata of the one or more 3D objects. The metadata may include a name or a description of a 3D object. For example, for the tire, the metadata may indicate a tire or a front driver-side tire. The metadata may also include the description indicating the age, the type, the brand, or other properties of the tire.

At 316, the client device 104 may transmit the volume report the server 102.

At 318, the server 102 selects 3D points out of the 3D point data using the 3D volumes in the volume report. In some embodiments, the server 102 selected 3D points that are encompassed by a combination of 3D volumes. For example, for the tire, the server 102 selects 3D points having coordinates encompassed by either the first or the second 3D volumes, but not encompassed by the third 3D volumes. The server 102 may select 3D points for other 3D objects similarly. In some embodiments, the server 102 may group the selected 3D points based on the corresponding 3D objects. For example, the server 102 may group 3D points for the front driver-side tire. As discussed above, the server 102 may add a label to these 3D points, such as (X, Y, Z, G) where “G” represents the front driver-side tire. Similarly, the server 102 may group 3D points for other 3D objects by labeling.

At 320, the server 102 may transmit the selected points with labels to other devices. For example, the server 102 may transmit the selected points to the client device 106 or the server 108 for further processing.

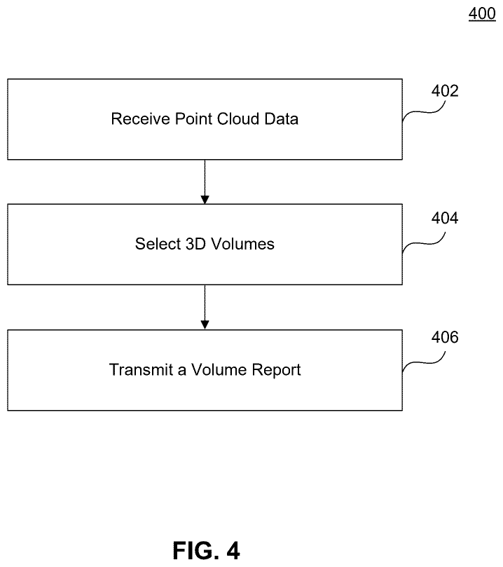

FIG. 4 illustrates an example method 400 of segmenting 3D objects at a client device, according to some embodiments of the disclosure. As a convenience and not a limitation, FIG. 4 may be described with regard to elements of FIGS. 1, 2, and 6. The example of a programming layout 400 may represent the operation of devices (e.g., the client device 104 of FIG. 1) implementing the 3D segmentation in a 3D objections segmentation system. The example of a programming layout 400 may also be performed by computer system 600 of FIG. 6. But the example of a programming layout 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4.

At 402, a client device, such as the client device 104, may receive point cloud data from a server, such as the server 102. The point cloud data represent a plurality of 3D objects. In some embodiments, the point cloud data include a number of 3D points. The number may be predetermined or corresponding to a capability of the client device 104.

At 404, the client device 104 selects one or more 3D volumes. A combination of the one or more 3D volumes segments a 3D object out of the plurality of 3D objects. In some embodiments, each of the one or more 3D volumes includes coordinates forming a 3D shape At 406, the client device 104 transmits a volume report to a graphic segmentation server. In some embodiments, the volume report includes the one or more 3D volumes.

The volume report may also include properties of the one or more 3D volumes. The properties may include an adding sign or a subtracting sign for reconstructing the 3D object. In some embodiments, the volume report may include metadata of the 3D object. The metadata may include a name or a description of the 3D object.

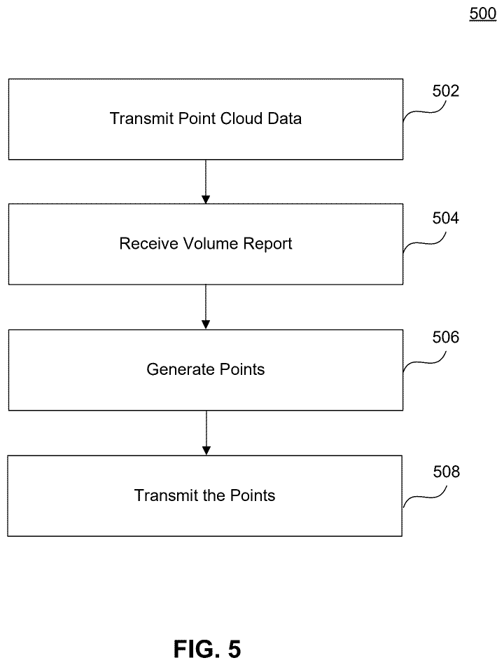

FIG. 5 illustrates an example method 500 of segmenting 3D objects at a server, according to some embodiments of the disclosure. As a convenience and not a limitation, FIG. 5 may be described with regard to elements of FIGS. 1, 2, and 6. The example of a programming layout 500 may represent the operation of devices (e.g., the server 102 of FIG. 1) implementing the 3D segmentation in a 3D objections segmentation system. The example of a programming layout 500 may also be performed by computer system 600 of FIG. 6. But the example of a programming layout 500 is not limited to the specific embodiments depicted in those figures and other systems may be used to perform the method, as will be understood by those skilled in the art. It is to be appreciated that not all operations may be needed, and the operations may not be performed in the same order as shown in FIG. 5.

At 502, a server, such as the server 102, may transmit point cloud data to a client device, such as the client device 104. The point cloud data represent a plurality of 3D objects. In some embodiments, the point cloud data include a number of 3D points. The number may be predetermined or corresponding to a capability of the client device 104.

At 504, the server 102 receive a volume report from the graphic segmentation device. In some embodiments, the volume report includes one or more 3D volumes that segment a 3D object out of the plurality of 3D objects. Each of the one or more 3D volumes includes coordinates forming a 3D shape.

At 506, the server 102 selects a plurality of 3D points based on the volume report. In some embodiments, the server 102 selects the plurality of 3D points from a first group of 3D points. The first group of 3D points may be the point data that the server 102 received and retrieved at 304 in FIG. 3. In addition, the point cloud data may include a second group of 3D points. The second group is a subgroup of the first group. The plurality of 3D points are located within a combination of the one or more 3D volumes.

For example, the server 102 may generate the combination by adding 3D volumes with “adding”sign and subtracting 3D volumes with “subtracting” sign.

At 508, the server 102 transmits the plurality of 3D points to another device, such as the client device 106 or the server 108.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

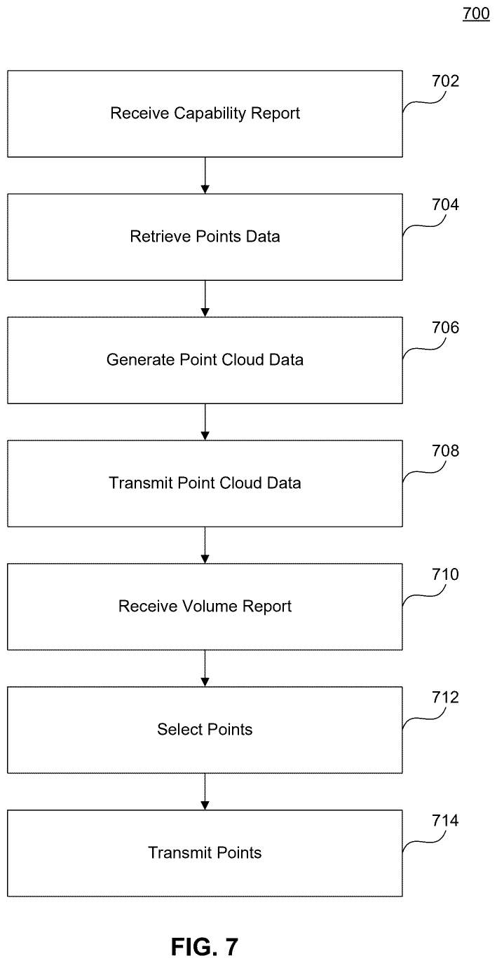

FIG. 7 illustrates an example method 300 of a server segmenting 3D objects, according to some embodiments of the disclosure. As a convenience and not a limitation, FIG. 7 may be described with regard to elements of FIGS. 1, 2, and 6. The example method 300 may represent the operation of devices (e.g., the server 102 of FIG. 1) implementing the 3D segmentation in a 3D objections segmentation system. The example method 300 may also be performed by computer system 600 of FIG. 6. But the example method 300 is not limited to the specific embodiments depicted in those figures and other systems may be used to perform the method, as will be understood by those skilled in the art. It is to be appreciated that not all operations may be needed, and the operations may not be performed in the same order as shown in FIG. 7.

At 702, a server, such as the server 102, may receive a capability report from a client device, such as the client device 104. The capability report may indicate hardware capabilities of the client device 104. In some embodiments, the hardware capabilities may include a storage capability, a processing capability, a communication capabilities, or others.

At 704, the server 102 may retrieve 3D point data from a memory of the server 102. In some embodiments, the server 102 may have previously received the 3D point data from a 3D scanning tool. As discussed above, the 3D scanning tool may be remotely located from the server 102 or integrated into the server 102. In either case, the 3D scanning tool may generate the 3D point data by scanning one or more 3D objects that are connected together. For example, the 3D scanning tool may scan an automobile that includes different 3D objects such as tires, lights, windows, front hood, back hood, bumpers, and so on. Because these 3D objects are connected to each other, the 3D scanning tool scans the 3D objects as a whole to generate the 3D point data. In other words, the 3D point data may include 3D points that are associate with different 3D objects. However, when the server 102 retrieves the 3D point data, the server 102 does not distinguish 3D points based on the associated 3D objects.

At 706, the server 102 may generate point cloud data based on the 3D point data. In some embodiments, the point cloud data may include the 3D points of the 3D point data. In other embodiments, the point cloud data may include a part of the 3D point data. For example, the server 102 may limit a number of 3D points to be included in the point cloud data. When the 3D point data include more 3D points than the limit, the server 102 may select a part of the 3D point data to be included in the point cloud data. For example, if the 3D point data may include 100,000 3D points, but the server 102 may limit the point cloud data to have 1,000 3D points, the server 102 may randomly select 1,000 3D points from the 100,000 3D points of the 3D point data. The server 102 may then generate the point cloud data using the 1,000 3D points selected. In some embodiments, the server 102 may select the 1,000 3D points by skipping other 3D points. For example, the 3D scanning tool may generate the 100,000 3D points in order by scanning the one or more 3D objects densely from top to bottom. Points that are generated close to each other represent a same area of the one or more 3D objects. Thus, to generate the point cloud data that represent the one or more 3D objects sparsely, the server 102 may skip a certain number of 3D points. For example, the server 102 may skip 99 3D points in every 100 3D points. In other words, the server 102 may use one 3D point to represent every 100 3D points. In this way, the server 102 selects 1,000 3D points out of 100,000 3D points to generate the point cloud data.

In some embodiments, the server 102 may determine the limit based the hardware capacities of the client device 104. For example, the client device 104 may indicate in the capability report that the client device 104 is capable of storing and processing X GB of data. In such a case, the server 102 may determine that 1,000 3D points require X GB storage space and thus limit the point cloud data to include no more than 1,000 3D points. In other embodiments, the client device 104 may indicate the limit directly. For example, the capability report may indicate that the point cloud data should include no more than 1,000 3D points.

At 708, the server 102 may transmit the point cloud data to the client device 104. The server 102 may transmit the point cloud data via a wireless connection, a wired connection, or a hybrid connection to the client device 104.

At 710, the server 102 may receive a volume report from the client device 104. In some embodiments, the volume report may include 3D volumes selected in the step 312 above. For the front driver-side tire, the volume report may include coordinates of the three 3D volumes as well as the label of the front driver-side tire. For example, the volume report may include an entry for the first 3D volume of the front driver-side tire as (C1, C2, C3, . . . , Cn, G, P). C1, C2, C3, . . . , Cn may be coordinates of corner points of the first volume, assuming that the first volume has n corner points. G may be the label of the front driver-side tire. G could be a number or a letter as long as it represents the front driver-side tire. P may be a combination property of the 3D volume, which can be either “adding” or “subtracting,” as discussed above. P can be a binary digit where “1” means “adding” and “0” means “subtracting.” The volume report may also include the second and third 3D volume of the front driver-side tire in a similar fashion. In this way, the volume report includes three 3D volumes needed for the tire. In addition, the volume report may include 3D volumes for other 3D objects similarly.

In some embodiments, the volume report may also include metadata of the one or more 3D objects. The metadata may include a name or a description of a 3D object. For example, for the tire, the metadata may indicate a tire or a front driver-side tire. The metadata may also include the description indicating the age, the type, the brand, or other properties of the tire.

At 712, the server 102 may select 3D points out of the 3D point data using the 3D volumes in the volume report. In some embodiments, the server 102 selected 3D points that are encompassed by a combination of 3D volumes. For example, for the tire, the server 102 selects 3D points having coordinates encompassed by either the first or the second 3D volumes, but not encompassed by the third 3D volumes. The server 102 may select 3D points for other 3D objects similarly. In some embodiments, the server 102 may group the selected 3D points based on the corresponding 3D objects. For example, the server 102 may group 3D points for the front driver-side tire. As discussed above, the server 102 may add a label to these 3D points, such as (X, Y, Z, G) where “G” represents the front driver-side tire. Similarly, the server 102 may group 3D points for other 3D objects by labeling.

At 714, the server 102 may transmit the selected points with labels to other devices. For example, the server 102 may transmit the selected points to the client device 106 or the server 108 for further processing.

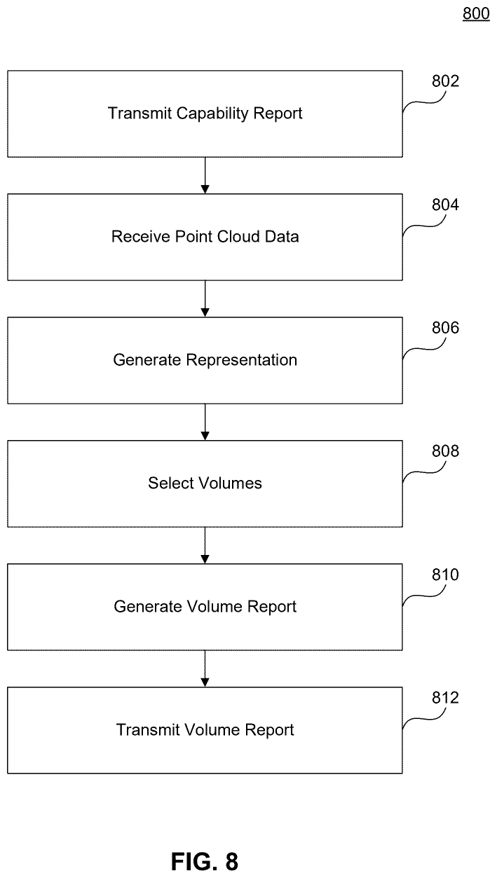

FIG. 8 illustrates an example method 800 of a client device segmenting 3D objects, according to some embodiments of the disclosure. As a convenience and not a limitation, FIG. 8 may be described with regard to elements of FIGS. 1, 2, and 6. The example method 800 may represent the operation of devices (e.g., the client device 104 of FIG. 1) implementing the 3D segmentation in a 3D objections segmentation system. The example method 800 may also be performed by computer system 600 of FIG. 6. But the example method 800 is not limited to the specific embodiments depicted in those figures and other systems may be used to perform the method, as will be understood by those skilled in the art. It is to be appreciated that not all operations may be needed, and the operations may not be performed in the same order as shown in FIG. 8.

At 802, a client device, such as the client device 104, may transmit a capability report to a server, such as the server 102. The capability report may indicate hardware capabilities of the client device 104. In some embodiments, the hardware capabilities may include a storage capability, a processing capability, a communication capabilities, or others.

At 804, the client device 104 may receive the point cloud data from the server 102. The client device 104 may receive the point cloud data via a wireless connection, a wired connection, or a hybrid connection to the server 102. In some embodiments, the point cloud data may include the 3D points of the 3D point data. In other embodiments, the point cloud data may include a part of the 3D point data, as discussed above in FIGS. 3 and 7.

At 806, the client device 104 may generate a 3D representation using the point cloud data. The level of details in the 3D representation may depend on the number 3D points in the point cloud data. In some embodiments, the client device 104 may down-sample the point cloud data by further reducing the number of 3D points in the point cloud data. Furthermore, the client device 104 may convert the point cloud data to a 3D mesh. For example, the client device 104 may connect neighboring 3D points to form triangular surfaces. In some embodiments, the client device 104 may display the 3D representation on a screen of the client device 104 so that a user of the client device 104 can observe the 3D representation. In some embodiments, the client device 104 may down-sample the point cloud data based on a resolution of the screen of the client device 104.

At 808, the client device 104 may select one or more volumes for each of the 3D objects according to instructions from the user. For example, for a tire of an automobile, the client device 104 may select the one or more volumes so that a combination of the one or more volumes encompasses the tire. In some embodiments, the one or more volumes may have a predetermined shape, such as a cuboid. The client device 104 may determine a size, a position, and an orientation of the one or more volumes. For example, the client device 104 may select a cuboid that encompasses the tire. In such a case, only a first 3D volume is needed. The client device 104 may adjust a size and an orientation of the first 3D volume to fit the tire and move the first 3D volume to a position of the tire. In some embodiments, the tire may be dual tires. In such a case, the client device 104 may select the first 3D volume and a second 3D volume, each encompasses one of the dual tires. For example, after adjusting the size and the orientation of the first and the second 3D volumes, the client device 104 may move the first and the second 3D volumes to the position of the tire. The client device 104 may also combine the first and the second 3D volumes by labeling both as associated with the tire. In some embodiments, the client device 104 also labels the first and the second 3D volumes as “add” or “adding” to indicate that the first and the second 3D volumes are to be added when combining each out. In some embodiments, the client device 104 may want to exclude spaces from existing selected 3D volumes. For example, the dual tire may include two tires connected by a connecting part. The first and the second 3D volumes may include the connecting part as well as the two tires. However, the client device 104 may want to exclude the connecting part leaving the two tires in the combination of 3D volumes. In such a case, the client device 104 may select a third 3D volume that encompasses just the connecting part. The client device 104 can then combine the first and the second 3D volumes with the third 3D volume by labeling the third 3D volumes as “subtracting. ” Thus, when combining the 3D volumes, the client device 104 or other devices may add the first and the second 3D volumes and then subtract the third 3D volume.

In some embodiments, the client device 104 may group 3D volumes for each 3D object by labeling them for each 3D object. For example, the client device 104 may select three 3D volumes for the tire as discussed above. The client device 104 may label the three 3D volumes as a front driver-side tire or a value corresponding to the front driver-side tire. The client device 104 may also select and group 3D volumes for other 3D objects similarly.

At 810, the client device 104 may generate a volume report. In some embodiments, the volume report may include 3D volumes selected in the step 312. For the front driver-side tire, the volume report may include coordinates of the three 3D volumes as well as the label of the front driver-side tire. For example, the volume report may include an entry for the first 3D volume of the front driver-side tire as (C1, C2, C3, . . . , Cn, G, P). C1, C2, C3, . . . , Cn may be coordinates of corner points of the first volume, assuming that the first volume has n corner points. G may be the label of the front driver-side tire. G could be a number or a letter as long as it represents the front driver-side tire. P may be a combination property of the 3D volume, which can be either “adding” or “subtracting,” as discussed above. P can be a binary digit where “1” means “adding” and “0” means “subtracting. ” The volume report may also include the second and third 3D volume of the front driver-side tire in a similar fashion. In this way, the volume report includes three 3D volumes needed for the tire. In addition, the volume report may include 3D volumes for other 3D objects similarly.

In some embodiments, the volume report may also include metadata of the one or more 3D objects. The metadata may include a name or a description of a 3D object. For example, for the tire, the metadata may indicate a tire or a front driver-side tire. The metadata may also include the description indicating the age, the type, the brand, or other properties of the tire.

At 812, the client device 104 may transmit the volume report the server 102.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Some non-limiting Examples of various embodiments are provided below.

Example 1 may include a graphic segmentation device comprising a memory and at least one processor coupled to the memory. The at least one processor is configured to receive point cloud data that represent a plurality of 3D objects and select one or more 3D volumes that segment a 3D object out of the plurality of 3D objects. Each of the one or more 3D volumes includes coordinates forming a 3D shape. The at least one processor is further configured to transmit a volume report to a graphic segmentation server, wherein the volume report includes the one or more 3D volumes.

Example 2 may include the graphic segmentation device of example 1 and/or some other examples herein, wherein the point cloud data includes a number of points, and wherein the number is predetermined.

Example 3 may include the graphic segmentation device of example 1 and/or some other examples herein, wherein the point cloud data includes a number of points, and wherein the number corresponds to a capability of the graphic segmentation device.

Example 4 may include the graphic segmentation device of example 3 and/or some other examples herein, wherein the at least one processor is further configured to generate a capability report that includes the capability of the graphic segmentation device or the number of points and transmit the capability report to the graphic segmentation server.

Example 5 may include the graphic segmentation device of example 1 and/or some other examples herein, wherein the volume report includes properties of the one or more 3D volumes and wherein the properties include an adding sign or a subtracting sign for reconstructing the 3D object.

Example 6 may include the graphic segmentation device of example 1 and/or some other examples herein, wherein the volume report includes metadata of the 3D object.

Example 7 may include the graphic segmentation device of example 6 and/or some other examples herein, wherein the metadata include a name or a description of the 3D object.

Example 8 may include a method of computer-implemented method for a graphic segmentation device. The method comprises receiving point cloud data that represent a plurality of 3D objects and selecting one or more 3D volumes that segment a 3D object out of the plurality of 3D objects. Each of the one or more 3D volumes includes coordinates forming a 3D shape. The method further comprises transmitting a volume report to a graphic segmentation server, wherein the volume report includes the one or more 3D volumes.

Example 9 may include the method of example 8 and/or some other examples herein, wherein the point cloud data includes a number of points and wherein the number is predetermined.

Example 10 may include the method of example 8 and/or some other examples herein, wherein the point cloud data includes a number of points and wherein the number corresponds to a capability of the graphic segmentation device.

Example 11 may include the method of example 10 and/or some other examples herein further comprising generating a capability report that includes the capability of the graphic segmentation device or the number and transmitting the capability report to the graphic segmentation server.

Example 12 may include the method of example 8 and/or some other examples herein, wherein the volume report includes properties of the one or more 3D volumes, and wherein the properties include an adding sign or a subtracting sign for reconstructing the 3D object.

Example 13 may include the method of example 8 and/or some other examples herein, wherein the volume report includes properties of the one or more 3D volumes, and wherein the properties include an adding sign or a subtracting sign for reconstructing the 3D object.

Example 14 may include a graphic segmentation server comprising a memory and at least one processor coupled to the memory. The at least one processor is configured to transmit point cloud data that represent a plurality of 3D objects to a graphic segmentation device and receive a volume report from the graphic segmentation device, wherein the volume report includes one or more 3D volumes that segment a 3D object out of the plurality of 3D objects, wherein each of the one or more 3D volumes includes coordinates forming a 3D shape. The at least one processor is further configured to select a plurality of points based on the volume report and transmit the plurality of points to another device.

Example 15 may include the graphic segmentation server of example 14 and/or some other examples herein, wherein to select the plurality of points, the at least one processor is further configured to select the plurality of points from a first group of points, wherein the plurality of points are located within the one or more 3D volumes.

Example 16 may include the graphic segmentation server of example 15 and/or some other examples herein wherein the point cloud data include a second group of points, and wherein the second group of points is a subgroup of the first group of points.

Example 17 may include the graphic segmentation server of example 16 and/or some other examples herein, wherein to transmit point cloud data, the at least one processor is further configured to determine that the second group of points includes a number of points; and select the number of points from the first group of points.

Example 18 may include the graphic segmentation server of example 17 and/or some other examples herein, the at least one processor is further configured to receive a capability report from the graphic segmentation device; and determine the number based on the capability report.

Example 19 may include the graphic segmentation server of example 14 and/or some other examples herein, wherein the volume report includes properties of the one or more 3D volumes, wherein the properties include an adding sign or a subtracting sign, and wherein the at least one processor is further configured to add 3D volumes of the one or more 3D volumes that have adding signs to form a total 3D volume; and subtract 3D volumes of the one or more 3D volumes that have subtracting signs; and select the plurality of points that have coordinates within the total 3D volume.

Example 20 may include the graphic segmentation server of example 14 and/or some other examples herein, wherein the volume report includes metadata of the 3D object, and wherein the metadata include a name or a description of the 3D object.

What is claimed is:

1. A graphic segmentation device, comprising:
a memory; and
at least one processor coupled to the memory and configured to:
receive point cloud data that represent a plurality of 3D objects;
select one or more 3D volumes that segment a 3D object out of the plurality of 3D objects, wherein each of the one or more 3D volumes includes coordinates forming a 3D shape; and
transmit a volume report to a graphic segmentation server, wherein the volume report includes the one or more 3D volumes.

2. The graphic segmentation device of claim 1,
wherein the point cloud data includes a number of points, and
wherein the number is predetermined.

3. The graphic segmentation device of claim 1,
wherein the point cloud data includes a number of points, and
wherein the number of points corresponds to a capability of the graphic segmentation device.

4. The graphic segmentation device of claim 3, wherein the at least one processor is further configured to:
generate a capability report that includes the capability of the graphic segmentation device or the number of points; and
transmit the capability report to the graphic segmentation server.

5. The graphic segmentation device of claim 1,
wherein the volume report includes properties of the one or more 3D volumes, and
wherein the properties include an adding sign or a subtracting sign for reconstructing the 3D object.

6. The graphic segmentation device of claim 1,
wherein the volume report includes metadata of the 3D object.

7. The graphic segmentation device of claim 6,
wherein the metadata include a name or a description of the 3D object.

8. A computer-implemented method for a graphic segmentation device, comprising:
receiving point cloud data that represent a plurality of 3D objects;
selecting one or more 3D volumes that segment a 3D object out of the plurality of 3D objects, wherein each of the one or more 3D volumes includes coordinates forming a 3D shape; and
transmitting a volume report to a graphic segmentation server, wherein the volume report includes the one or more 3D volumes.

9. The computer-implemented method of claim 8,
wherein the point cloud data includes a number of points, and
wherein the number of points is predetermined.

10. The computer-implemented method of claim 8,
wherein the point cloud data includes a number of points, and
wherein the number of points corresponds to a capability of the graphic segmentation device.

11. The computer-implemented method of claim 10, further comprising:
generating a capability report that includes the capability of the graphic segmentation device or the number of points; and
transmitting the capability report to the graphic segmentation server.

12. The computer-implemented method of claim 8,
wherein the volume report includes properties of the one or more 3D volumes, and
wherein the properties include an adding sign or a subtracting sign for reconstructing the 3D object.

13. The computer-implemented method of claim 8,
wherein the volume report includes metadata of the 3D object, and
wherein the metadata include a name or a description of the 3D object.

14. A non-transitory computer-readable medium comprising instructions to, upon execution of the instructions by one or more processors of a graphic segmentation device, cause the graphic segmentation device to perform operations, the operations comprising:
receiving point cloud data that represent a plurality of 3D objects;
selecting one or more 3D volumes that segment a 3D object out of the plurality of 3D objects, wherein each of the one or more 3D volumes includes coordinates forming a 3D shape; and
transmitting a volume report to a graphic segmentation server, wherein the volume report includes the one or more 3D volumes.

15. The non-transitory computer-readable medium of claim 14,
wherein the point cloud data includes a number of points, and
wherein the number of points is predetermined.

16. The non-transitory computer-readable medium of claim 14,
wherein the point cloud data includes a number of points, and
wherein the number of points corresponds to a capability of the graphic segmentation device.

17. The non-transitory computer-readable medium of claim 16, wherein the operations further comprise:
generating a capability report that includes the capability of the graphic segmentation device or the number of points; and
transmitting the capability report to the graphic segmentation server.

18. The non-transitory computer-readable medium of claim 14,
wherein the volume report includes properties of the one or more 3D volumes, and
wherein the properties include an adding sign or a subtracting sign for reconstructing the 3D object.

19. The non-transitory computer-readable medium of claim 14,
wherein the volume report includes metadata of the 3D object.

20. The non-transitory computer-readable medium of claim 19,
wherein the metadata include a name or a description of the 3D object.
